(19) United States
(12) Patent Application Publication
(10) Pub. No.: US 2001/0034758 A1
(43) Pub. Date: Oct. 25, 2001

(54) Virtual private network (VPN) for servicing home gateway system through external disk management

(76) Inventor: Dan Kikinis, Saratoga, CA (US)

Correspondence Address: CENTRAL COAST PATENT AGENCY, PO BOX 187, AROMAS, CA, 95004, US

(21) Appl. No.: 09/791,511

(22) Filed: Feb. 21, 2001

Related U.S. Application Data
(60) Provisional application No. 60/184,728, filed on Feb. 24, 2000.

(51) Int. Cl. G06F 15/16; G06F 15/173

(52) U.S. Cl. 709/203; 709/223

(57) ABSTRACT

A local area network is provided. The local area network comprises, at least one Internet-capable appliance connected to the local area network for controlling integration of the local area network to a wide area network, a least one additional appliance connected to the local area network, the appliance capable of communication with data sources operating on the wide area network, a control device for recording and controlling aspects of connectivity and configuration of appliances connected to the local area network and a mass storage device accessible to the control device and to entities operating on the wide area network. A primary service provider maintains control over the controlling device for the purpose of enabling secondary providers of services to access the mass storage device and selected portions of the control device in order to effect and manage services as dictated and permitted by the primary service provider.

### CROSS REFERENCE TO RELATED DOCUMENTS

The present application claims priority and is a conversion from Provisional application serial number 60/184,728, filed on Feb. 24, 2000 and is incorporated herein in it's entirety by reference

### FIELD OF THE INVENTION

The present invention is in the field of home entertainment and pertains in particular to methods for servicing home gateway systems through external disk management.

### BACKGROUND OF THE INVENTION

At the current time and state of evolution of the well-known Internet network, more and more individuals and businesses are realizing dramatic growth in the number of devices that are used to access and interact with the Internet. In the US, the fastest growing segment is second PCs or other Internet appliances for homes. There are a dramatically growing number of devices available that share or use a remote dial-up device capable of accessing the Internet. Those remote dial-up devices or systems are the familiar telephone modems and more recently developed DSL and ADSL lines and satellite accessible Internet connection. Internet appliances that share such modems and other connections are essentially stand-alone devices that share a common connectivity network in the home or business. The devices work interactively over a connectivity network with PCs and other Internet appliances and require relatively complex setup procedures to interface with PCs, appliances or other interconnected devices.

A group configuration of such customer premise equipment (CPE) is known generally as a home-network system. Other complexities in the use and interconnection of the array of devices in a home network system include origination identification, personal security, connection protocols to service providers, and firewalls to prevent unauthorized access to the client's networked components and data. The array of devices requires the establishment and maintenance of a considerable amount of set-up configuration and management to ensure reliable interactive operation.

The services that are provided for home use include many well known Internet-based services and all various facets including, news services, movies, music, games, financial and brokerage services, travel services, Internet banking, and more that are perceived on the immediate horizon. In addition, various devices that are representative of telephony technology are potential Internet appliances that are included in, or available to at-home networks.

One of various capabilities needed to take advantage of the multitude of services available over the Internet is mass storage of data. A typical home user seldom has storage beyond that provided by a typical PC or other Internet appliance. However, one of the more outstanding accomplishments in computer capabilities over the last 20 years has been the development of large and inexpensive storage capabilities. Current art computers contain hard drives of 10 Gigabytes and greater. However the use of services available and on the horizon require storage well beyond what is practical in typical desk-top PCs and this aspect would require a user operating a typical at-home network to dedicate to much memory resource to the system. The multiplicity of possible devices in a home or office network eventually amounts to a considerable number of pieces of equipment that a user must setup, configure, and regularly manage to maintain equipment interaction. The purchase cost and time required for attention to the various interconnected devices can become considerable.

What is clearly needed is a method for easily setting up an at-home network that has mass storage capability and automates the integration of a multitude of Internet appliances and includes all the equipment hook-up data and connection protocols to available service providers that provide Internet services, telephony services, and value added services.

Furthermore, a high level of security needs to be provided, in order to address concerns regarding the possible un-authorized use of intellectual property multi media.

### SUMMARY OF THE INVENTION

In a preferred embodiment of the present invention, a local area network is provided. The local area network comprises, at least one Internet-capable appliance connected to the local area network for controlling integration of the local area network to a wide area network, a least one additional appliance connected to the local area network, the appliance capable of communication with data sources operating on the wide area network, a control device for recording and controlling aspects of connectivity and configuration of appliances connected to the local area network and a mass storage device accessible to the control device and to entities operating on the wide area network.

A primary service provider maintains some control over the controlling device for the purpose of enabling secondary providers of services including deliverable commodities to access the mass storage device and selected portions of the control device in order to effect and manage services in a fashion dictated and permitted by the primary service provider.

In a preferred aspect, the wide area network is the Internet network. Also in a preferred aspect, the control device is utilized to control appliance configurations and activation on the local area network and to control service configurations and activation for services obtained from the wide area network. The mass storage device is partitioned into a plurality of virtual data storage areas. Each virtual data storage area is dedicated to a specific one or ones of an entity providing a service for services accessible from the local area network. In a preferred embodiment, network access granted to individual ones of virtual data storage areas are conducted through separate virtual private networks established and associated with each virtual disk. In this embodiment, the control device includes a removable memory card, the card containing user authentication data and device configuration data as well as service identification and configuration data.

In another aspect of the present invention, a server software is provided for managing remote network access for service entities to a control device connected to a mass storage device, the control device and mass storage device connected to a local area network. The server software comprises, a portion thereof for partitioning the mass storage device into a plurality of virtual data storage areas, a portion thereof for communicating to the control device and for communicating to the service entities, a portion thereof for establishing separate virtual networks, the networks assigned to individual ones of the virtual data storage areas and a portion thereof for managing authentication and security over the virtual networks. A primary service provider maintaining the server software grants permission for selected service entities to setup and configure services on the control device including establishing the virtual networks between the individual service entities and the control device wherein the individual entities are assigned an individual or shared portion of a data storage area partitioned from the mass storage device and wherein the individual entities are granted limited control over the assigned virtual storage areas.

In a preferred embodiment, the control device and a mass storage device are integrated as one unit. In one embodiment, the local area network is a home-based network. In another embodiment, the local area network is a business-based network. In a preferred embodiment, the local area network is integrated to a wide area network. In this embodiment, the wide area network is preferably the Internet network. In all aspects, the control device is utilized to control appliance configurations and activation on the local area network and to control service configurations and activation for services obtained from the wide area network.

In one aspect, each virtual data storage area is dedicated to a specific one or ones of the service entities providing a service for services accessible from the local area network. In preferred aspects, the control device includes a removable memory card, the card containing user authentication data and device configuration data as well as service identification and configuration data.

In yet another aspect of the present invention, a network-based system is provided for facilitating secure private networks between service entities operating on a wide area network, the service entities serving a client operating on a local area network. The system comprises, a system server connected to the wide area network for serving as a network management facility accessible to the service entities, a server software hosted on the system server for establishing the secure private networks, a control device connected to the local area network for integrating devices on the network and for establishing an interface to the system server, a mass storage device connected to the control device on the local area network for storing data, and a user authentication key insert able to the control device for authenticating a user to the local area network and for identifying, configuring, and activating services made available by the service entities. The server software communicating with the control device partitions the mass storage device into a plurality of data storage areas, the data storage areas dedicated individually, in shared fashion, or both to the service entities such that the service entities have limited control over assigned storage areas and secure access to the storage areas through established virtual private networks.

In a preferred embodiment, the system server is controlled by a primary service provider and the service entities are secondary service providers. Also in a preferred embodiment, the network includes both the wide area network and the local area network and wherein the wide area network is the Internet network. In one aspect, the user authentication key is a removable memory card, the card containing user authentication data and device configuration data as well as service identification and configuration data. In this aspect, the user authentication key is modular and may be used at a new location to automatically configure a new local area network to establish services.

Now, for the first time, a method for easily setting up an at-home network that has mass storage capability and automates the integration of a multitude of Internet appliances and includes all the equipment hook-up data and connection protocols to available service providers that provide Internet services, telephony services, and value added services is provided.

### BRIEF DESCRIPTIONS OF THE DRAWING FIGURES

FIG. 1 is an architectural overview of a home network system CPE according to an embodiment of the present invention.

FIG. 2 is an architectural overview of a network communication system providing and managing services to and for the home network system of FIG. 1.

FIG. 3 is a block diagram illustrating components of the IAD device of FIG. 1.

### DESCRIPTION OF THE PREFERRED EMBODIMENTS

According to an embodiment of the present invention a method and apparatus is provided for enabling users to easily set up a home or office network at home or at a business location that enables automated interconnectivity and enabled interaction of a multiplicity of Internet appliances comprising a home network system for access to the Internet and other network-based service providers. The method and apparatus of the invention is detailed below.

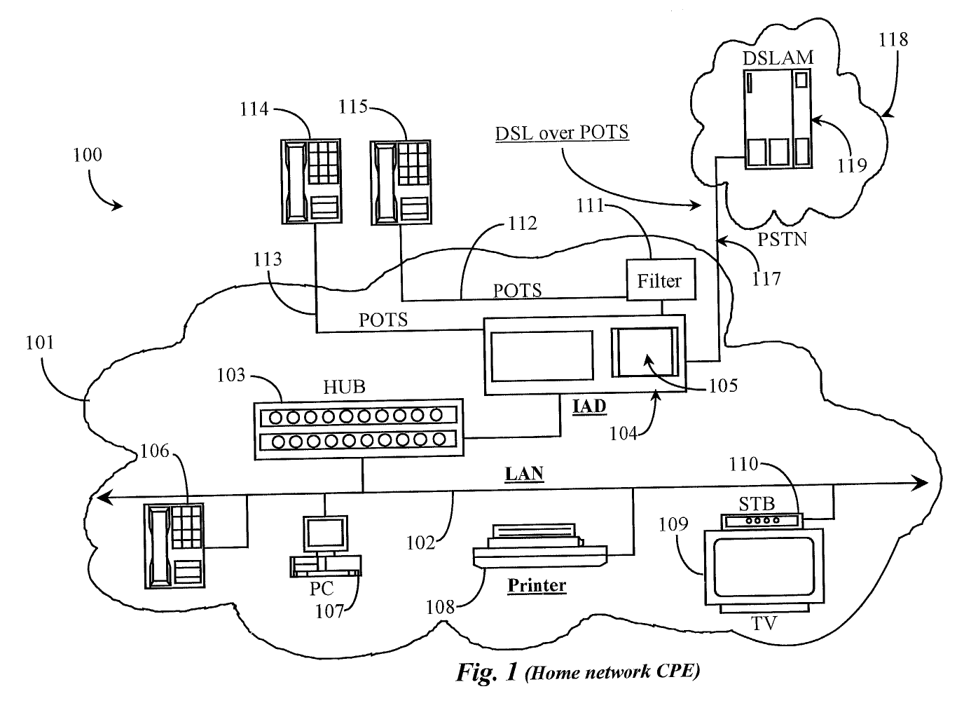

FIG. 1 is an architectural overview of a home-network of Customer Premise Equipment (CPE) 100 according to an embodiment of the present invention. CPE 100 includes a home-network system 101, connecting various elements of common telephony and network access capability including telephones 106, 114, and 115, a PC 107, a printer 108, a TV 109, a Set Top Box (STB) 110, all interconnected by virtue of a LAN 102 to an equipment hub 103 that interfaces with a unique Integrated Access Device (IAD) 104. IAD 104 is adapted to provide integrated access to the Internet and telephony services on-behalf of all connected devices. In this embodiment, LAN 102 is implemented as a standard 100 base TLAN structure to keep the architecture reasonably open for fast data communication. However, in other embodiments, LAN 102 could also include normal home telephone wiring, wireless LAN's etc.

Home network CPE 100 as illustrated herein is exemplary only and is not meant to indicate any required equipment or device array. The inventor intends to illustrate only that many of the devices illustrated may be included in a home-network. For example, telephones 114 and 115 are connected to IAD 104 via normal plane old telephone service (POTS) lines 113 and 112 respectively. It is noted herein that in this case, POTS telephone 115 is an IP-Ethernet feature phone connected to IAD 104 through a Voice over Internet Protocol (VoIP) filter as is Generally known in the art. IAD 104 interfaces CPE network 101 to the well-known public switched telephony service represented herein as cloud 118.

Home network CPE 100 connects, in this embodiment, to the Internet through PSTN 118 via an available Digital Subscriber Line (DSL) 117 of an Incumbent Local Exchange Carrier (ILEC) and/or a Competitive Local Exchange Carrier (CLEC) (not shown). A Digital Subscriber Line Access Multiplexer (DSLAM) 119 is provided within PSTN 118 and provides DSL services. DSLAM 119 is a mechanism at a telephone company's central office that links many customer DSL connections to a single high-speed Asynchronous Transfer Mode (ATM) line (not shown). The DSLAM includes an Asymmetric DSL modem with a POTS splitter that detects voice and data traffic and routes voice calls to PSTN and data to DSLAM.

Telephone 106, connected to LAN 102, is an IP phone. In this embodiment it is reiterated that specific equipment and function may vary widely. All that is required to practice the present invention is a plurality (more than one) of devices and IAD 104. A novel element of IAD 104 is a mass storage disk 105 termed a QuaDDisk™ by the inventor. QuaDDisk™ 105 is partition able into at least four virtual disks that will be described further in this specification. Data downloaded to QuaDDisk™ 105 over DSL line 117 is stored in an appropriate one of a plurality of virtual partitions or “virtual disks” that are managed in terms of access and use by a remote entity. The nature of each partition is such that it is dedicated to a particular service entity in terms of data downloaded and uploaded during communication between the client via specific devices and the service providing entity of which there may be several.

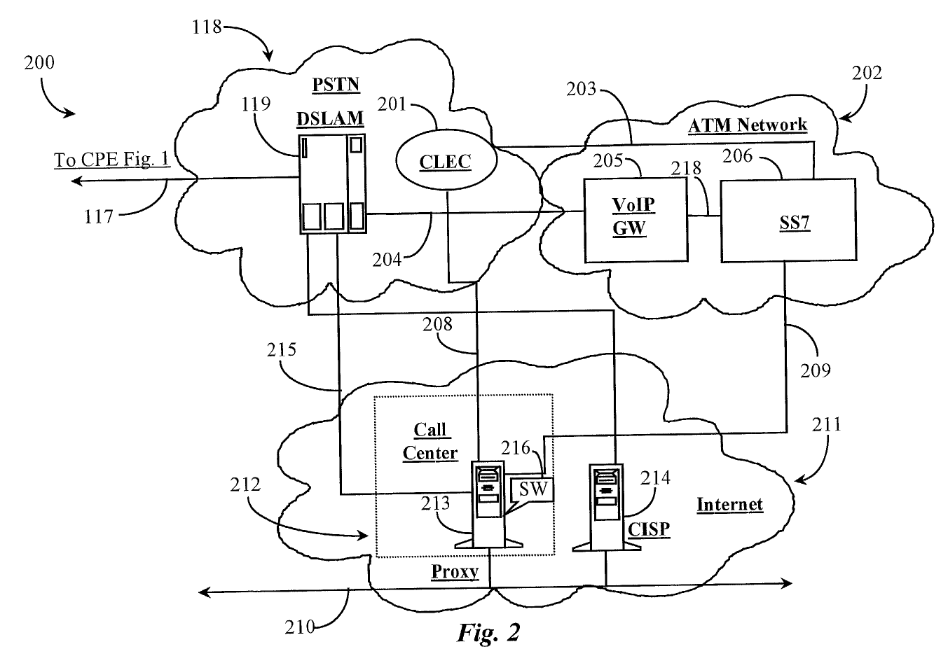

FIG. 2 is an architectural overview of a network communication system 200 for enabling services to and managing various aspects of home network CPE 101 of FIG. 1. In the interest of avoiding redundancy, elements identified in FIG. 1 that are also present in this example will not be re-introduced. Network communication system 200 is an architecture that is adapted to service a home network system analogous to system 101 of FIG. 1 over DSL 117 as described in FIG. 1. Line 117 may include any of the following current art capabilities: Asymmetrical Digital Subscriber Line (ADSL), High-Speed DSL (HDSL), ISDN DSL (IDSL), Symmetrical DSL (SDSL), Universal ADSL (UADSL), and Very High Bit-Rate DSL (VDSL). Line 117 may, in one embodiment, be an ISDN connection line. It is not specifically required that line 117 be a DSL line. Other connection schemes and hence connection lines may be utilized, including but not limited to fiber, wireless WAN technologies (e.g. LMDS et al.) and so forth.

In this example, intermediate components are illustrated herein and in FIG. 1. These are DSLAM 119, PSTN 118, and DSL 117. DSLAM 119 is adapted to link many customer DSL connections to a single high-speed ATM line as was previously described. In general, when the phone company receives a DSL signal, an ADSL modem with a POTS splitter detects voice calls and data. Voice calls are sent to the PSTN, and data are sent to the DSLAM, where it passes through the ATM network to the Internet then back through the DSLAM and ADSL modem before returning to the customer's PC.

Architecture 200 further includes, in addition to components illustrated in FIG. 1, a competitive local exchange carrier (CLEC) 201, an asynchronous transfer network ATM 202, and the well-known Internet network 211. ATM 202 illustrates a network technology based on transferring data in cells or packets of a fixed size. The cell used with ATM is relatively small compared to units used with older data-packet technologies. The small, consistent cell size allows ATM equipment to transmit video, audio, and computer data over the same network, and assure that no single type of data hogs the line.

Information traversing network communication system 200 is optionally and preferably processed over ATM network 202 utilizing a Signaling System 7 gateway (SS7) 206 and a Voice over Internet Protocol gateway (VoIP GW) 205 for formatting. VoIP GW 205 is connected to SS7 206 by a data line 218. SS7 is a telecommunication protocol defined by the International Telecommunication Union (ITU) as a way to offload PSTN data traffic congestion onto a wireless or wireline digital broadband network. SS7 is characterized by high-speed packet switching and out-of-band signaling using Service Switching (SSP), Signal Transfer Points (STP) and Service Control Points (SCP), collectively referred to as signaling points, or SS7 nodes. Some bandwidth is sacrificed by running VoIP in ATM format however this loss is made up in reduced latency and overhead since fewer conversions are required. VoIP GW 205 within ATM 202 is connected to DSLAM 119 by a data trunk 204. Other protocols may also be used instead, in some cases.

A call center 212 is illustrated within network architecture 200 and is adapted, in this example, as a service center controlling various aspects of client service and external access to certain areas of the previously mentioned QuaDDisk™ 205 of FIG. 1. A Proxy server 213 is illustrated, in this example as hosted within the premise of call center 212. Server 213 has a SW application 216 provided therein and adapted to enable center 212 to control which entities are able to engage in secure transaction with a client through use of a novel virtual private network (VPN) capability that is “tiered” creating separate secure environments termed VPNs through which the entities may do business with the client. In one embodiment, server 213 may be hosted externally from center 212. SW 216 may be hosted on a node other than server 213 without departing from the spirit and scope of the invention. The inventor illustrates server 213 as an interfacing server accessible, by contract arrangement, to secondary service providers operating on the network. In general, VPN tiers equate to secure access networks to specific portions of QuadDisk 105 of FIG. 1 that are dedicated for remote control and management.

Proxy server 213 is used to enable automated setup, control, and management the IAD of FIG. 1 from the network level. In a preferred embodiment an ILEC provider will own and operate proxy server 213 in a call center. In another embodiment server 213 may be held externally from any call center having access thereto. In a second layer beneath the primary control level, CLEC 201 has access granted to all of the illustrated elements required for completing it's service whatever it may be. A CLEC may be a local call service provider. It is noted herein that more than one CLEC of different service description may be granted access to a single VPN tier and hence an area of QuadDisk™ 105 of FIG. 1. Below the second layer a User Visible Provider (UVP) (not illustrated), either CLEC or ILEC, is allowed to choose what third party Value Added Service Providers (VASPs) will get access to the required parameters and functions of service including billing activity. It is noted herein that there may be more than one UVP that has access to VPN capability without departing from the spirit and scope of the present invention.

VPNs are controlled by proxy server 213 as previously described. In one embodiment access to certain aspects of functionality of a home network enhanced with IAD 104 of FIG. 1 such as billing and setting up services for specific devices are handled through separate call centers maintained by separate entities, the call centers having access to proxy 213. For example, a call center (212) maintained by the main service provider such as, perhaps Pac Bell, may also own and operate proxy 213. A separate call center (not shown) maintained by CLEC 201 has access to proxy 213 for VPN access purposes. Another call center (not shown) may be maintained by a competitive Internet service provider (CISP), the ISP entity hosting a connection server 214, and would have access to proxy 213 via an illustrated Internet backbone 210. In this way, a main provider retaining primary control may allow only those entities authorized to do business with a client access to certain virtual partitions of QuaDDisk™ 205 of FIG. 1. Architecture 200 is bi-directional in terms of communication paths and physical connections. Firewalls, and other secure network protocols are employed in each allowed VPN level.

In addition to VPN access for billing and service delivery, VPN architecture (software 216) may be utilized by permission of a controlling entity to perform certain configurations to IAD 104 of FIG. 1. For example, if a CLEC is AT&T for local calls, then proxy 213 may be utilized to configure a telephony port with a virtual telephone number for one of existing telephones 114, 115, of FIG. 1. In this way, a new (telephone) number may be added to home network 101 without requiring additional equipment or a technician intervention at the customer premises. There are many possibilities.

It will be apparent to one with skill in the art that the physical connections between components represented in this example may be represented in other ways such as logical communication paths without departing from the spirit and scope of the present invention. The inventor intends that the physical connections, namely connections 204, 203, 209, 208, 215 and 210 represent exemplary connections only and simply serve to show network connectivity between components of architecture 200. Moreover, there are many bi-directional network paths that may be utilized in accordance with VPN enabled architecture 200 when practicing the present invention such varied paths depending on such circumstances as may be warranted by the type (including purpose) of data being communicated and the parties communicating. In general, all data to and from CPE of FIG. 1 travels through DSLAM 119 in this example. However, other types of network connectivity schemes between CPE and network level components may be utilized including wireless schemes without departing from the spirit and scope of the present invention. DSL is chosen as a preferred embodiment because of efficiency in downloading media rich data, and is at the moment most cost-effective. However, depending on the circumstances, in some cases terrestrial wireless, or other technologies such as fiber to the home, laser-links, satellite etc. may be used instead, or in some combination.

The aspect of enabling secure networks between a client and selected service providers is novel in that such providers have permitted levels of control and access to client CPE, namely QuadDisk™ in this example. Providers may sell services and bill over a VPN. Commodities from providers such as rentable services including subscriptions, movies, music and the like may be sent to a client but not accessible to the client until negotiated service parameters are met. For example, a service provider, perhaps a movie rental business, may send movies ordered by a client for storage on QuadDisk™ 105 (FIG. 1) wherein the client's use of such commodities is monitored by the service provider through novel disk management through a secure VPN. If a client fails to meet service requirements, then he or she cannot access the dedicated portion of disk wherein the movies are stored or at least, may not effectively play them. There are many customizable situations. The inventor uses a movie provider in this example for purposes of discussion only. This store and forward process allows to have an event exceed by far the sustained downstream capacity of the link to the customer premise, but to still maintain control, for example to avoid unauthorized copying.

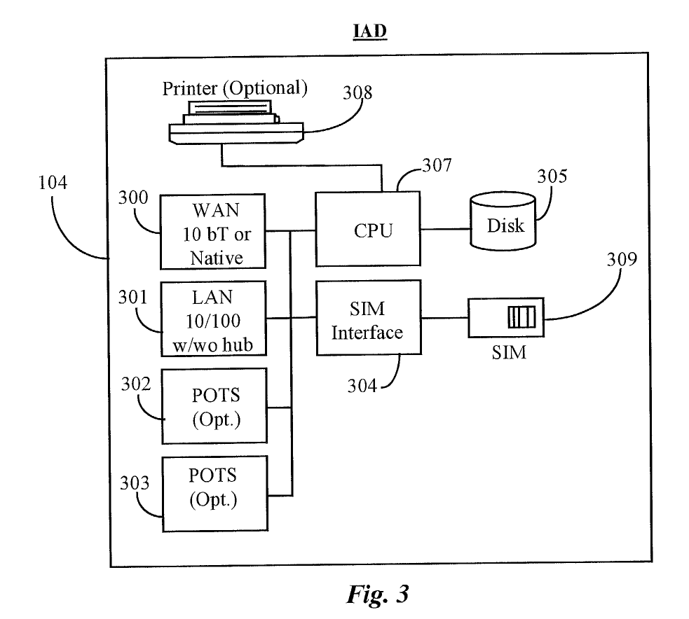

FIG. 3 is a block diagram of inner architecture of IAD 104 of FIG. 1. IAD 104 comprises a CPU 307, a storage disk 305 (Analogous to disk 105 of FIG. 1). A wide-area-network (WAN) port configuration module 300 is provided within IAD 104 and represents all of the required components including circuitry for configuring a WAN network to IAD 104. In this example, WAN module 300 enables a 10 Base T (10 bT) or similar native network system. A LAN configuration module 301 is provided within IAD 104 and represents all of the required components and circuitry for configuring a LAN network to IAD 104. In this example, module 301 enables a 10 base/100 base LAN with or without a hub.

In addition to the above, an optional POTS configuration module 302 and an optional POTS configuration module 303 are provided within IAD 104 and represent all of the components and circuitry required to enable POTS telephony equipment and service. An optional printer port 308 is provided within IAD 104 and represents all of the components and circuitry required to enable connection of a shared printer or printers.

Disk 305 is partitionable such that it may be separated into virtual disks, each virtual disk dedicated to a VPN tier. IAD 104 of FIG. 1 is host to the novel combination of hardware and software that provide the solution to the integration and configuration complexities of multiple appliances to the multiplicity of telephony and Internet-based services available to the client.

A subscriber identity module (SIM) interface 304 is provided within IAD 104 and adapted to provide secure authentication of an authorized client. Module 304 accepts a Chip Key™ SIM 309, which is provided to clients of the service. SIM components 304 and 309 provide a secure interface that serves to identify a client, and confirm all configuration protocols and service arrangements made part of the home-network of FIG. 1. It is noted herein that an office network may be identically enhanced. Disk 305 is preferably dense to provide mass storage capability beyond that of a conventional PC disk. Disk 305 has enough memory to store full-length movies, which may be obtained from a network-based movie house, music files, data libraries and much other media rich materials. Also, in some other cases, other methods of ID may be used, such as passwords, biometrics, document scanners etc., all alone, or in any combination with each other and the SIM. In some cases now SIM will be present, and only one or more of the other methods will be used for authentication.

All of the inner components of IAD 104 are interconnected in this example by a PCI bus structure. In this way, updating and reconfiguration may be performed in an open architectural environment. SIM key 309 contains required user authentication data for various services and for the primary service provider including all current configuration assignments and service provider identifications, and all required protocols for Disk partitioning and VPN parameters. SIM data is managed in a database (not shown) at proxy 213 of FIG. 2.

The partitioned areas, or virtual disks, of QuadDisk™ 305 include but are not limited to an area for the system that is accessible only by VPN of the Primary Service Provider (not illustrated); a user only area for spooling and NAS functions, behind a firewall; at least one Value Added Service Provider secure delivery area, behind a firewall; and at least one so-called Demilitarized Zone (DMZ) area for WEB proxy and unsecured data delivery outside a firewall. The partitioning of the disk allows various service providers such as rental movie providers, to provide secure content to the user's disk and maintain control over allowed services such as how many times a movie may be viewed, how long the user may have use of the movie, preventing user duplications, billing for allowed services, and other controls that may be conceived.

SIM 309 in the present embodiment of the invention is a card similar to that used in Government secure telephony systems albeit much enhanced. The ChipKey (SIM 309) provides automated setup and remote local network control, as well as remote management of certain functions of the IAD and certifiable identification of users to service providers. The novel ChipKey enables a user to quickly setup a plug and play CPE architecture on an existing network and easily activate services. All parameters related to protocols equipment settings and service identifications, including access and activation parameters are recorded in the SIM device, or in a related secure storage in the network (not shown), or both. In this way, a user who moves and sets up at a new location may easily reestablish and activate a new network including all of the same services and equipment formerly established. Once all equipment is interconnected at a new location and a ChipKey is inserted in a SIM module (304), all service providers automatically recognize the new architecture and site and service at the new site can be initiated. A database in proxy 213 of FIG. 2 is implemented to manage the ChipKey parameters as was described above. Further, this allows to replace a lost, stolen or defective SIM, by re-linking it with the data from the secure network storage. As previously described, the novel proxy server technology based on VPN capability as illustrated with reference to server 213 of FIG. 2, allows a natural flow of provisioning, security, verification, and billing items between all service providers and users. ChipKeys (SIMS) are registered in a database along with all current configuration, identification, and all permitted hardware, software, and services.

It will be apparent to one skilled in the art that the methods and apparatus described above are illustrated in an exemplary fashion in a preferred or best mode and there may be considerable alterations in the arrangement and configuration of alternate embodiments while not deviating from the spirit and scope of the present invention. The method and apparatus of the present invention may be practiced by private individuals or businesses on various forms of LAN or WAN and the Internet. Any known combination of Internet server network and service providers including telephony providers may be utilized. There are many customizable situations. The present invention as taught herein and above should be afforded the broadest of scope. The spirit and scope of the present invention is limited only by the claims that follow.

What is claimed is:

1. Any and all inventions disclosed in this document.

2. A local area network comprising:
at least one Internet-capable appliance connected to the local area network for controlling integration of the local area network to a wide area network;
a least one additional appliance connected to the local area network, the appliance capable of communication with data sources operating on the wide area network;
a control device for recording and controlling aspects of connectivity and configuration of appliances connected to the local area network; and
a mass storage device accessible to the control device and to entities operating on the wide area network;
characterized in that a primary service provider maintains some control over the controlling device for the purpose of enabling secondary providers of services including deliverable commodities to access the mass storage device and selected portions of the control device in order to effect and manage services in a fashion dictated and permitted by the primary service provider.

3. The local area network of claim 2, wherein the wide area network is the Internet network.

4. The local area network of claim 2, wherein the control device controls appliance configurations and activation on the local area network and controls service configurations and activation for services obtained from the wide area network.

5. The local area network of claim 2, wherein the mass storage device is partitioned into a plurality of virtual data storage areas.

6. The local area network of claim 5, wherein each virtual data storage area is dedicated to a specific one or ones of an entity providing a service for services accessible from the local area network.

7. The local area network of claim 6, wherein network access granted to individual ones of virtual data storage areas are conducted through separate virtual private networks established and associated with each virtual disk.

8. The local area network of claim 2, wherein the control device includes a removable memory card, the card containing user authentication data and device configuration data as well as service identification and configuration data.

9. A server software for managing remote network access for service entities to a control device connected to a mass storage device, the control device and mass storage device connected to a local area network comprising:
a portion thereof for partitioning the mass storage device into a plurality of virtual data storage areas;
a portion thereof for communicating to the control device and for communicating to the service entities;
a portion thereof for establishing separate virtual networks, the networks assigned to individual ones of the virtual data storage areas; and
a portion thereof for managing authentication and security over the virtual networks;
characterized in that a primary service provider maintaining the server software grants permission for selected service entities to setup and configure services on the control device including establishing the virtual networks between the individual service entities and the control device wherein the individual entities are assigned an individual or shared portion of a data storage area partitioned from the mass storage device and wherein the individual entities are granted limited control over the assigned virtual storage areas.

10. The server software of claim 9, wherein the control device and a mass storage device are integrated as one unit.

11. The server software of claim 9, wherein the local area network is a home-based network.

12. The server software of claim 9, wherein the local area network is a business-based network.

13. The server software of claim 9, wherein the local area network is integrated to a wide area network.

14. The server software of claim 9, wherein the wide area network is the Internet network.

15. The server software of claim 13, wherein the control device controls appliance configurations and activation on the local area network and controls service configurations and activation for services obtained from the wide area network.

16. The server software of claim 9, wherein each virtual data storage area is dedicated to a specific one or ones of the service entities providing a service for services accessible from the local area network.

17. The server software of claim 9, wherein the control device includes a removable memory card, the card containing user authentication data and device configuration data as well as service identification and configuration data.

18. A network-based system for facilitating secure private networks between service entities operating on a wide area network, the service entities serving a client operating on a local area network comprising:
a system server connected to the wide area network for serving as a network management facility accessible to the service entities;
a server software hosted on the system server for establishing the secure private networks;
a control device connected to the local area network for integrating devices on the network and for establishing an interface to the system server;
a mass storage device connected to the control device on the local area network for storing data; and
a user authentication key insert able to the control device for authenticating a user to the local area network and for identifying, configuring, and activating services made available by the service entities;
characterized in that the server software communicating with the control device partitions the mass storage device into a plurality of data storage areas, the data storage areas dedicated individually, in shared fashion, or both to the service entities such that the service entities have limited control over assigned storage areas and secure access to the storage areas through virtual private networks.

19. The network-based system of claim 18, wherein the system server is controlled by a primary service provider and the service entities are secondary service providers.

20. The network-based system of claim 18, wherein the network includes both of the wide area network and the local area network and wherein the wide area network is the Internet network.

21. The network-based system of claim 18, wherein the user authentication key is a removable memory card, the card containing user authentication data and device configuration data as well as service identification and configuration data.

22. The network-based system of claim 21, wherein the user authentication key is modular and may be used at a new location to automatically configure a new local area network to establish services.
